(19) United States
(12) Patent Application Publication
(10) Pub. No.: US 2026/0365455 A1
(43) Pub. Date: Nov. 19, 2026

(54) PLANAR-MOTOR DRIVE SYSTEM AND CORRESPONDING CLEANING DEVICE

(71) Applicant: Provisur Technologies, Inc., Chicago, IL (US)

(72) Inventors: Jurgen BIALY, Oeschebuttel (DE); Aainani ABDESSAMAD, Bad Gronenbach (DE)

(73) Assignee: Provisur Technologies, Inc., Suite 720, IL (US)

(21) Appl. No.: 19/137,035

(22) PCT Filed: Mar. 5, 2024
(86) PCT No.: PCT/EP2024/055748

§ 371 Date: Jun. 9, 2025

(30) Foreign Application Priority Data
Apr. 19, 2023 (DE) 10 2023 109 901.9

(51) Int. Cl. B65G 54/02; A23L 5/20; B08B 13/00; B65G 43/00; B65G 47/04

(52) U.S. Cl. CPC B65G 54/02; B08B 13/00; B65G 43/00; B65G 47/04; A23L 5/20; B65G 2201/0202

(57) ABSTRACT

A planar-motor drive system for conveying goods to be conveyed includes a conveying surface, a conveyed goods carrier which has a loading surface on its upper side for loading the conveyed goods carrier, and an electromagnetic drive system for moving the at least one conveyed goods carrier on the conveying surface along a conveying path parallel to the conveying surface. A handling device for picking up the conveyed goods carrier from the conveying surface and for transferring the conveyed goods carrier to a cleaning device for cleaning the conveyed goods carrier in the cleaning device is provided. The cleaning device may include a magazine for receiving a plurality of conveyed goods carriers.

### TECHNICAL FIELD OF THE

The invention relates to a planar-motor drive system for conveying goods to be conveyed (e.g. food products). Furthermore, the invention relates to a corresponding cleaning device for cleaning a conveyed goods carrier of the planar-motor drive system according to the invention.

### BACKGROUND TO THE INVENTION

It is known from the prior art (e.g. DE 10 2021 105 103 A1) to convey food products (e.g. stacks of cheese slices or sausage slices) by means of a planar-motor drive system. For this purpose, the planar-motor drive system has a horizontal conveying surface, wherein a plurality of conveyed goods carriers are movably arranged on the upper side of the conveying surface, which are also referred to as “shuttles” or “movers” and can be moved by an electromagnetic drive system along a conveying path parallel to the conveying surface. The electromagnetic drive system can be, for example, the system marketed by the German company Beckhoff Automation Gmbh & Co. KG under the product name XPlanar®.

The problem here is the cleaning of the individual conveyed goods carriers, which is occasionally necessary during operation due to the contamination caused by the conveyed food products. The electromagnetic drive system of the planar-motor drive system is sensitive to moisture, so that cleaning by spraying with a high-pressure cleaner is not possible.

For the technical background of the invention, reference should also be made to KR 10 2063 156 B1 and JP 2019-102 658 A.

### DESCRIPTION OF THE INVENTION

The invention is therefore based on the task of solving the problem of cleaning the individual conveyed goods carriers in such a planar-motor drive system.

This task is solved by a planar-motor drive system according to the invention or by a corresponding cleaning device according to the independent claims.

The planar-motor drive system according to the invention is generally used for conveying goods, such as food products. The food products can be, for example, stacks of slices of sausage or slices of cheese. However, the invention is not limited to food products with regard to the goods to be conveyed, but can in principle also be realized with other types of goods to be conveyed.

In accordance with the prior art, the planar-motor drive system according to the invention also has a conveying surface, which is preferably arranged horizontally and accommodates an electromagnetic drive system beneath it, which makes it possible to move conveyed goods carriers on the conveying surface along a conveying path parallel to the conveying surface, such conveyed goods carriers also being referred to as “shuttles” or “movers” in accordance with the usual technical terminology.

For example, the electromagnetic drive system can be the system marketed by the German company Beckhoff Automation Gmbh & Co. KG under the product name XPlanar®.

Alternatively, it is possible that the electromagnetic drive system is the system marketed by the German company Bosch Rexroth AG under the product name ctrlX FLOW6D®.

In general, it should be mentioned that the invention is not limited to the two above-mentioned examples with regard to the design and operation of the electromagnetic drive system, but can also be realized with other types of electromagnetic drive systems.

In the known planar-motor drive system described at the beginning, the individual conveyed goods carriers are removed from the conveying surface of the planar-motor drive system by hand for cleaning so that the individual conveyed goods carriers can then be cleaned separately from the planar-motor drive system using a high-pressure jet. However, this known method of cleaning the individual conveyed goods carriers is very time-consuming. The invention therefore provides for the planar-motor drive system to have a handling device in order to be able to pick up the conveyed goods carriers from the conveying surface of the planar-motor drive system and transfer them to a separate cleaning device, the cleaning device itself being described in detail later.

In a preferred embodiment of the invention, the handling device is mounted on a first edge of the conveying surface of the planar-motor drive system and projects with a cantilever arm from the first edge of the conveying surface over the conveying surface in order to be able to pick up a conveyed goods carrier located on the conveying surface from the conveying surface. The cantilever arm preferably extends at a right angle from the first edge of the conveying surface over the conveying surface. In addition, the cantilever arm preferably has a mounting flange, wherein the cantilever arm is preferably detachably mounted with its mounting flange on the first edge of the conveying surface in order to be able to mount the cantilever arm at various positions along the first edge of the conveying surface.

The cantilever arm of the handling device extends from the first edge of the conveying surface, preferably as far as an opposite second edge of the conveying surface, in order to transfer the conveyed goods carrier to be cleaned to the cleaning device at the second edge of the conveying surface or to take over the cleaned conveyed goods carrier from the cleaning device, the cleaning device being positioned next to the second edge of the conveying surface of the planar-motor drive system. During a cleaning process, the cleaning device is therefore first placed next to the conveying surface of the planar-motor drive system, which will be described in more detail. The handling device can then pick up the individual conveyed goods carriers from the conveying surface and transfer them to the cleaning device or pick up the cleaned conveyed goods carriers from the cleaning device again and place them on the conveying surface of the planar-motor drive system.

In the preferred embodiment of the invention, the cantilever arm of the handling device comprises a swivel mechanism with a pick-up. The pick-up can be swiveled by the swivel mechanism into one of the following three positions:
a vertically raised starting position,
a vertically lowered pick-up position, or
a vertically raised and horizontally extended transfer position for transferring the conveyed goods carrier to be cleaned to the cleaning device or for receiving the cleaned conveyed goods carrier from the cleaning device.

In the raised starting position, the pick-up of the handling device is raised from the conveying surface of the planar-motor drive system so that the movement of the conveyed goods carriers on the conveying surface of the planar-motor drive system is not disturbed. During normal operation of the drive system, the handling device therefore assumes the starting position.

In the lowered pick-up position of the pick-up, on the other hand, the pick-up grips under the conveyed goods carrier to be picked up on the conveying surface of the planar-motor drive system so that it can then be lifted.

In the horizontally extended transfer position, however, the pick-up protrudes beyond the edge of the conveying surface of the planar-motor drive system in order to transfer a conveyed goods carrier to be cleaned to the cleaning device or to pick up a cleaned conveyed goods carrier from the cleaning device.

The swivel mechanism of the handling device preferably has a displaceable carriage in order to move the swivel mechanism between the starting position, the pick-up position and the transfer position. A drive motor (e.g. electric motor) is preferably provided for displacing the carriage, whereby the drive motor preferably acts on the carriage via a traction drive (e.g. toothed belt) in order to displace the carriage. The drive motor for the carriage is preferably arranged on the upper side of the cantilever arm and preferably has an output shaft that is aligned essentially vertically.

It should also be mentioned that the swivel mechanism can have a parallelogram guide that connects the carriage to the pick-up. When the pick-up is swiveled, the parallelogram guide ensures that the pick-up always maintains a certain angular alignment regardless of the swivel position. Preferably, the pick-up is always aligned horizontally so that the conveyed goods carrier picked up by the pick-up is also aligned horizontally.

In the preferred embodiment of the invention, the planar-motor drive system has a control unit, which can control both the electromagnetic drive system and the handling device in accordance with a cleaning program. When running the cleaning program, the individual conveyed goods carriers on the conveying surface are moved one after the other to the handling device so that the handling device can pick up the conveyed goods carriers one after the other from the conveying surface of the planar-motor drive system and transfer them to the cleaning device. The cleaning program thus advantageously enables automatic transfer of all conveyed goods carriers to the cleaning device. The planar-motor drive system on the one hand and the conveyed goods carriers on the other can then be cleaned separately. The conveyed goods carriers can then be cleaned using a high-pressure cleaner, for example, as the individual conveyed goods carriers do not contain any moisture-sensitive electronic components. In contrast, the conveying surface of the planar-motor drive system should preferably not be cleaned using a high-pressure cleaner, as the planar-motor drive system with the electromagnetic drive system contains moisture-sensitive components.

In general, it should be mentioned that the conveying surface of the planar-motor drive system is preferably oriented essentially horizontally. Furthermore, it should be noted that the conveying surface of the planar-motor drive system is preferably flat, smooth and continuous, as is also case with the known planar-motor drive system. Furthermore, it should also be noted that the electromagnetic drive system preferably operates without contact, i.e. without any contact between the conveying surface and the individual conveyed goods carriers. The individual conveyed goods carriers are preferably rectangular in plan view, as is also the case in the prior art. In addition, it should generally be noted that the conveying path of the conveyed goods carrier within the conveying surface is preferably freely programmable. The electromagnetic drive system can be composed of numerous rectangular drive modules which, when assembled, form the continuous conveying surface of the planar-motor drive system.

In addition to the planar-motor drive system according to the invention with the handling device described above, the invention also claims independent protection for an associated cleaning device for cleaning the conveyed goods carriers of the planar-motor drive system. The cleaning device according to the invention is characterized by a magazine, which enables a plurality of conveyed goods carriers to be held simultaneously, whereby the conveyed goods carriers can then be cleaned in the magazine of the cleaning device.

In a preferred embodiment of the invention, the magazine is a drum magazine, which has a plurality of receiving positions each for one conveyed goods carrier, wherein the drum magazine with the receiving positions for the individual conveyed goods carriers is rotatable about an axis of rotation. The individual receiving positions for the individual conveyed goods carriers are preferably distributed around the circumference of the drum magazine, whereby the drum magazine can be rotated by a drive motor (e.g. electric motor). The axis of rotation of the drum magazine is preferably aligned horizontally.

The individual receiving positions of the drum magazine are preferably designed such that the individual conveyed goods carriers in the drum magazine are each aligned in a radial plane with respect to the axis of rotation of the drum magazine, so that each conveyed goods carrier located in the drum magazine is accessible for cleaning from above with its underside in one rotational position of the drum magazine and with its upper side in another rotational position of the drum magazine. This makes it possible to clean all the conveyed goods carriers by spraying them from above using a high-pressure jet, whereby both the top and the bottom of all the conveyed goods carriers can be cleaned by rotating the drum magazine.

Furthermore, it should be mentioned that the magazine (e.g. drum magazine) of the cleaning device according to the invention preferably has an access opening in order to introduce the conveyed goods carriers to be cleaned into the magazine or to remove the cleaned conveyed goods carriers from the magazine. This access opening preferably has a locking mechanism which only allows a carrier to be removed from the magazine or a carrier to be inserted into the magazine when it is unlocked. The locking mechanism of the access opening of the magazine preferably works automatically, whereby the access opening unlocks automatically when the cleaning device is coupled to the handling device of the planar-motor drive system, whereas the locking mechanism of the magazine locks automatically when the cleaning device is uncoupled from the handling device of the planar-motor drive system.

The magazine (e.g. drum magazine) for the individual conveyed goods carriers is preferably arranged in a wire mesh cage that is permeable to a cleaning fluid and allows the conveyed goods carriers in the magazine to be cleaned from the outside by spraying them with the cleaning fluid. For example, the conveyed goods carriers in the magazine can be sprayed from the outside with a high-pressure cleaner.

The wire mesh cage preferably has a sufficiently small mesh size to prevent manual access from the outside to the conveyed goods carriers inside the wire mesh cage.

In addition, the cleaning device preferably has a chassis with several wheels for rolling the cleaning device on a floor. In this way, the cleaning device can be rolled to the side of the planar-motor drive system for a cleaning process. The individual castors of the chassis can be lockable in order to prevent the cleaning device from rolling away unintentionally when locked.

In addition, the rollable cleaning device can have a handrail so that the cleaning device can be easily moved on the floor by an operator. The handrail preferably runs in a horizontal direction and at least partially surrounds the magazine with the individual conveyed goods carriers.

In general, it should be mentioned that the magazine can, for example, have at least 3, 5, 10, 15 or at least 20 receiving positions each for one conveyed goods carrier to be cleaned.

In addition, it should be mentioned that the drum magazine can have a diameter of at least 50 cm, 75 cm or 1 m in order to provide sufficient storage space for the individual conveyed goods carriers.

Other advantageous embodiments of the invention are characterized in the dependent claims or are explained in more detail below together with the description of the preferred embodiment of the invention with reference to the figures.

### BRIEF DESCRIPTION OF THE DRAWINGS

FIG. 1 shows a perspective view of a planar-motor drive system according to the invention with a cleaning device according to the invention, which is docked onto the planar-motor drive system.

FIG. 2 shows a perspective view of the cleaning device with the handling device of the planar-motor drive system.

FIG. 3 shows a perspective view of the cleaning device without the planar-motor drive system.

FIG. 4 shows a side view of the handling device of the planar-motor drive system in a raised starting position.

FIG. 5 shows the handling device in a lowered pick-up position.

FIG. 6 shows the handling device in a horizontally extended transfer position.

### DETAILED DESCRIPTION OF THE DRAWINGS

In the following, the embodiment of a planar-motor drive system 1 with an associated cleaning device 2 according to the invention shown in the drawings is described.

The planar-motor drive system 1 can have a largely conventional structure and initially comprises a frame 3 which contains an electromagnetic drive system on its underside in order to be able to move conveyed goods carriers 4 on a conveying surface 5 without contact along a freely programmable conveying path. The electromagnetic drive system can, for example, be the system marketed by the German company Beckhoff Automation GmbH und Co KG under the product designation XPlanar®, but the invention is not limited to this product with regard to the type of electromagnetic drive system, but can also be realized, for example, with the system marketed by the German company Bosch Rexroth AG under the product designation ctrlX FLOW6DR.

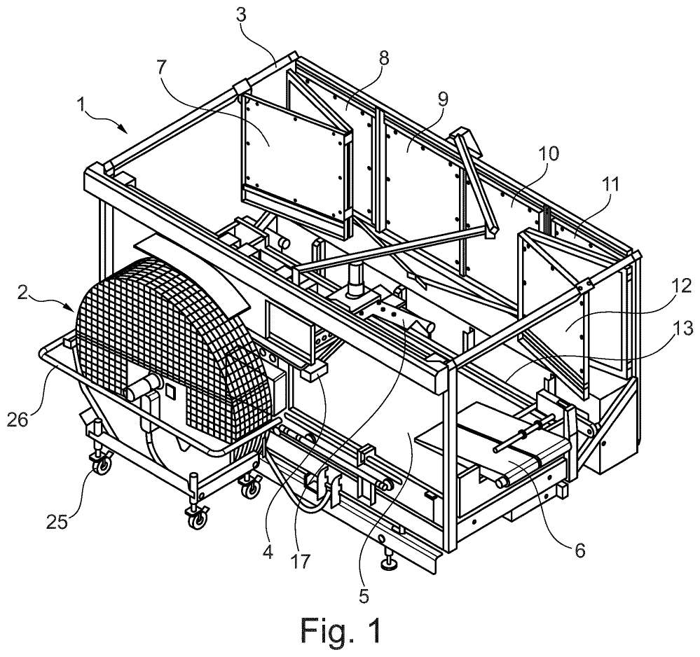

The planar-motor drive system 1 comprises an input conveyor 6, from which the food products to be conveyed (e.g. stacks of cheese slices or sausage slices) are conveyed onto the conveying surface 5. In addition, the planar-motor drive system 1 can have a corresponding output conveyor, which is concealed by the cleaning device 2 in FIG. 1. Further details of the planar-motor drive system 1 are described, for example, in the German patent application DE 10 2021 105 105 A1.

In addition, the planar-motor drive system 1 comprises several covers 7-12 on the side, which are pivotable and make it possible to close the frame 3 laterally.

The special feature according to the invention here is that a handling device 14 is attached to an edge 13 of the conveying surface 5 opposite the cleaning device 2, which serves to pick up the individual conveyed goods carriers 4 from the conveying surface 5 of the planar-motor drive system 1 and transfer them to the cleaning device 2, as will be described in detail later. In addition, the handling device 14 also serves to pick up the cleaned conveyed goods carriers 4 from the cleaning device 2 and place them back on the conveying surface 5 of the planar-motor drive system 1.

The handling device 14 initially comprises a mounting flange 15, with which the handling device 14 is attached to the edge 13 of the conveying surface 5 of the planar-motor drive system 1. The attachment of the handling device 14 to the edge 13 of the conveying surface by means of the mounting flange 15 is detachable, so that the handling device 14 can be attached at any position along the edge 13 of the conveying surface 5.

A cantilever arm 16 extends from the mounting flange 15 of the handling device 14, which has an inclined arm 17 and a horizontal arm 18 that are slightly angled towards each other.

The horizontal arm 18 of the cantilever arm 16 contains a guide rail 19 for a displaceable carriage 20, the carriage 20 being displaceable along the guide rail 19.

A drive motor 21, which is arranged on the upper side of the horizontal arm 18 of the cantilever arm 16 and acts on the carriage 20 via a toothed belt, is used to move the carriage 20 along the guide rail 19.

In addition, the handling device 14 has a pick-up 22 which makes it possible to lift the conveyed goods carrier 4 from the conveying surface 5 or to set it down on the conveying surface 5.

The pick-up 22 is connected to the carriage 20 via a parallelogram guide 23. The parallelogram guide 23 ensures that the pick-up 22 is always aligned horizontally, regardless of the swivel position.

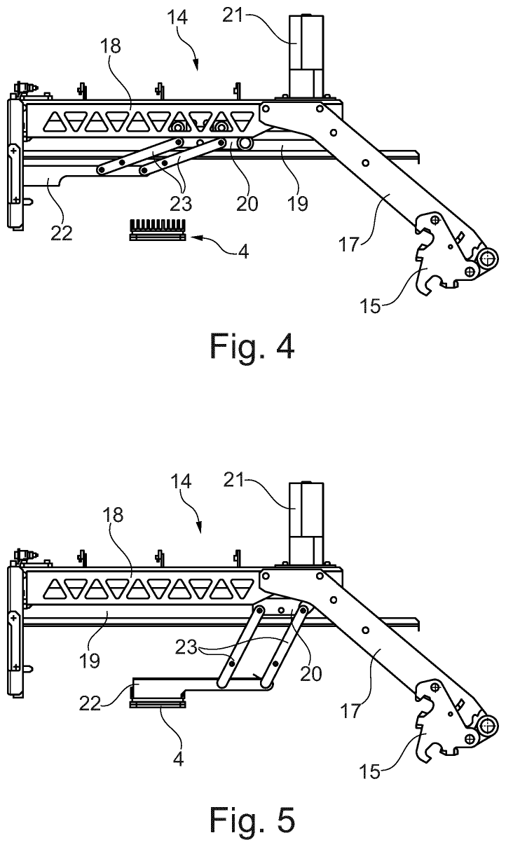

FIG. 4 shows an initial position of the pick-up 22. In this initial position, the pick-up 22 is raised from the conveying surface 5 of the planar-motor drive system 1, so that the conveyed goods carriers 4 can move freely on the conveying surface 5 without the pick-up 22 interfering with the movement of the conveyed goods carriers 4.

FIG. 5, on the other hand, shows a vertically lowered pick-up position of the pick-up 22. In this pick-up position, the pick-up 22 grips under the conveyed goods carrier 4 on the conveying surface 5 so that the conveyed goods carrier 4 can then be lifted off the conveying surface 5.

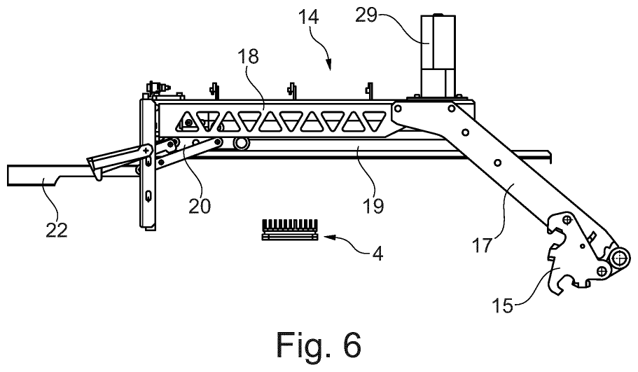

FIG. 6 shows a transfer position for transferring the conveyed goods carrier 4 to the cleaning device 2 or for receiving the cleaned conveyed goods carrier 4 from the cleaning device 2. In this transfer position, the pick-up 22 is lifted vertically from the conveying surface 5 of the planar-motor drive system 1 and extended in a horizontal direction towards the cleaning device 2.

The movement between the starting position (FIG. 4), the pick-up position (FIG. 5) and the transfer position (FIG. 6) is effected by a corresponding displacement of the carriage 20 along the guide rail 19.

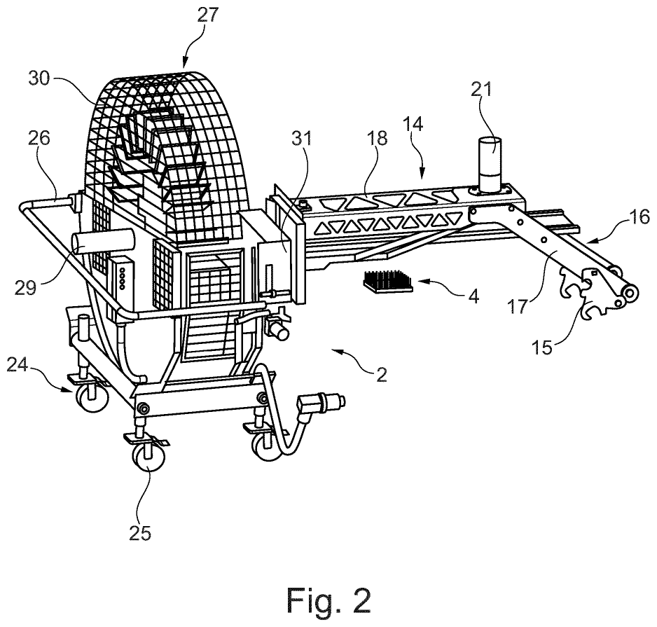

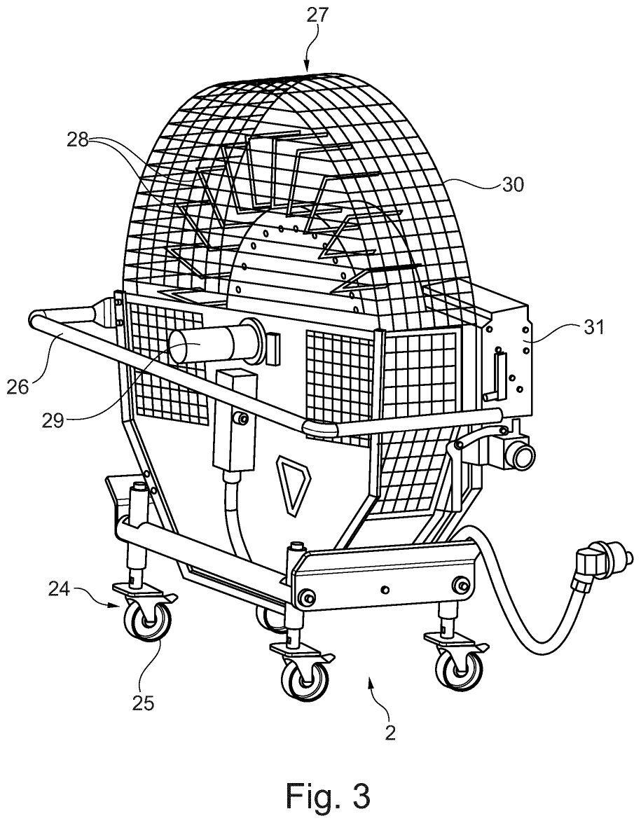

The cleaning device 2 is now described in more detail below, with particular reference being made to FIGS. 1, 2 and 3.

The cleaning device 2 initially has a chassis 24 with several lockable wheels 25. The cleaning device 2 can thus be rolled laterally towards the planar-motor drive system 1 by means of the chassis 24, as shown in FIG. 1.

Here, an operator can grip the cleaning device 2 at a laterally circumferential handrail 26 and roll the cleaning device 2 into the desired position to the side of the planar-motor drive system 1.

The cleaning device 2 has a drum magazine 27, which contains numerous holding positions 28, each for one of the conveyed goods carriers 4. The drum magazine 27 can be rotated about a horizontal axis of rotation by a drive motor 29.

The individual receiving positions 28 for the respective conveyed goods carriers 4 are located within a wire mesh cage 30, which is permeable to a cleaning fluid. The conveyed goods carriers 4 located in the drum magazine 27 can therefore be cleaned from the outside by spraying a cleaning fluid through the wire mesh cage 30 onto the conveyed goods carriers 4 in the receiving positions 28 of the drum magazine 27 by means of a high-pressure cleaner.

In addition, the cleaning device 2 has an access opening 31 through which the individual conveyed goods carriers 4 can be inserted into the drum magazine 27 or removed from the drum magazine 27. The access opening 31 has an automatic locking mechanism, which locks automatically when the handling device 14 is uncoupled from the cleaning device 2, whereas the locking mechanism unlocks automatically when the handling device 14 is coupled to the cleaning device 2.

The invention is not limited to the preferred embodiment described above. Rather, a large number of variants and modifications are possible which also make use of the inventive concept and therefore fall within the scope of protection. In particular, the invention also claims protection for the subject matter and the features of the dependent claims independently of the claims referred to in each case and, in particular, also without the features of the independent claims. The invention thus comprises various aspects of the invention which enjoy protection independently of each other.

### ADVANTAGES OF THE INVENTION

The invention offers the following advantages, among others:
The conveyed goods carriers can be cleaned separately from the planar-motor drive system. A high-pressure cleaner can therefore be used to clean the conveyed goods carriers, as no attention needs to be paid to the moisture-sensitive components of the planar-motor drive system.
While the conveying surface of the planar-motor drive system is being cleaned, the conveyed goods carriers can be temporarily stored in the magazine of the cleaning device.
The conveyed goods carriers and the planar-motor drive system can be cleaned at the same time.
The transfer of the individual conveyed goods carriers between the planar-motor drive system and the cleaning device can take place automatically, which is safer than a manual transfer by an operator. The invention thus offers maximum safety for the operating personnel.

### LIST OF REFERENCE SIGNS

1 Planar-motor drive system
2 Cleaning device
3 Frame of the planar-motor drive system
4 Conveyed goods carrier
5 Conveying surface of the planar-motor drive system
6 Input conveyor of the planar-motor drive system
7-12 Covers of the planar-motor drive system
13 Edge of the conveying surface of the planar-motor drive system
14 Handling device of the planar-motor drive system
15 Mounting flange of the cantilever arm
16 Cantilever arm of the handling device
17 Inclined arm of the cantilever arm
18 Horizontal arm of the cantilever arm
19 Guide rail
20 Carriage
21 Drive motor for the carriage
22 Pick-up for picking up the conveyed goods carrier
23 Parallelogram guide
24 Chassis of the cleaning device
25 Wheels of the cleaning device chassis
26 Handrail of the cleaning device
27 Drum magazine of the cleaning device
28 Drum magazine receiving positions for the individual conveyed goods carriers
29 Drive motor for rotating the drum magazine
30 Wire mesh cage of the drum magazine
31 Access opening of the drum magazine

1-15. (canceled)

16. A planar-motor drive system for conveying goods to be conveyed to a second device, the planar-motor drive system comprising:
a conveying surface;
at least one conveyed goods carrier, which has a loading surface on its upper side for loading the conveyed goods carrier with the goods to be conveyed;
an electromagnetic drive system for moving the at least one conveyed goods carrier on the conveying surface along a conveying path parallel to the conveying surface; and
a handling device mounted to the conveying surface and configured to engage with the conveyed goods carrier and to move the conveyed goods carrier from the conveying surface to the second device.

17. The planar-motor drive system according to claim 16, wherein the handling device is mounted on a first edge of the conveying surface and projects with a cantilever arm from the first edge of the conveying surface over the conveying surface in order to be able to pick up a conveyed goods carrier located on the conveying surface from the conveying surface.

18. The planar-motor drive system according to claim 17, wherein the cantilever arm projects at right angles from the first edge of the conveying surface over the conveying surface.

19. The planar-motor drive system according to claim 17, wherein the cantilever arm has a mounting flange and is detachably mounted with the mounting flange on the first edge of the conveying surface in order to be able to mount the cantilever arm at various positions along the first edge of the conveying surface.

20. The planar-motor drive system according to claim 17, wherein the cantilever arm of the handling device extends from the first edge of the conveying surface to an opposite second edge of the conveying surface, in order to transfer the conveyed goods carrier to be cleaned to the second device at the second edge of the conveying surface or to take over the cleaned conveyed goods carrier from the second device, the second device being located next to the second edge of the conveying surface.

21. The planar-motor drive system according to claim 17, wherein
the cantilever arm of the handling device carries a swivel mechanism with a pick-up, the pick-up is configured to be swiveled by the swivel mechanism selectively into one of the following three positions:
a vertically raised starting position,
a vertically lowered pick-up position, or
a vertically raised and horizontally extended transfer position for transferring the conveyed goods carrier to be cleaned to the second device or for receiving the cleaned conveyed goods carrier from the second device,
the pick-up of the handling device in the raised starting position is raised from the conveying surface and does not interfere with movement of the conveyed goods carriers on the conveying surface,
the pick-up of the handling device in the lowered pick-up position grips under the conveyed goods carrier to be picked up on the conveying surface in order to be able to lift the conveyed goods carrier from the conveying surface, and
the pick-up of the handling device in the horizontally extended transfer position, guides the picked-up conveyed goods carrier beyond the edge of the conveying surface and feeds it to the second device.

22. The planar-motor drive system according to claim 21, wherein
the swivel mechanism of the handling device comprises a displaceable carriage in order to move the swivel mechanism between the starting position, the pick-up position and the transfer position;
the carriage is displaceable along a guide rail; and
a drive motor is provided for displacing the carriage.

23. The planar-motor drive system according to claim 22, wherein
the drive motor for the carriage is arranged on the upper side of the cantilever arm, and
the drive motor for the carriage has an output shaft which is oriented substantially vertically.

24. The planar-motor drive system according to claim 21, wherein the swivel mechanism has a parallelogram guide which connects the carriage to the pick-up.

25. The planar-motor drive system according to claim 16, further comprising
a control unit configured to control the electromagnetic drive system and the handling device in accordance with a program, and the control unit is configured to control the electromagnetic drive system and the handling device during execution of the program in such a way that all the conveyed goods carriers located on the conveying surface are transferred one after the other by the handling device to the second device.

26. The planar-motor drive system according to claim 16, wherein
the conveying surface is oriented essentially horizontally, and
the conveying surface is flat, smooth and continuous, and
the electromagnetic drive system operates contactlessly without any contact between the conveying surface and the conveyed goods carrier.

27. The planar-motor drive system according to claim 16, wherein
the at least one conveyed goods carrier is rectangular when viewed from above, and
the conveying path of the conveyed goods carrier within the conveying surface is freely programmable, and
the electromagnetic drive system has a plurality of rectangular drive modules which are assembled adjacent to one another and together form the continuous conveying surface of the planar-motor drive system.

28. The planar-motor drive system according to claim 16, further comprising the second device which is configured to clean the conveyed goods carrier transferred by the handling device.

29. The planar-motor drive system according to claim 28, wherein the second device comprises a magazine for simultaneously receiving a plurality of conveyed goods carriers for cleaning the conveyed goods carriers in the magazine.

30. The planar-motor drive system according to claim 29, wherein
the magazine is a drum magazine,
the drum magazine has a plurality of receiving positions (28), each for one conveyed goods carrier,
the drum magazine with the receiving positions for the conveyed goods carriers is rotatable about an axis of rotation,
the receiving positions for the individual conveyed goods carriers are distributed around a circumference of the drum magazine.

31. The planar-motor drive system according to claim 30, wherein
a drive motor is provided to rotate the drum magazine about the axis of rotation, and
the axis of rotation of the drum magazine is aligned horizontally.

32. The planar-motor drive system according to claim 31, wherein the receiving positions of the drum magazine are designed in such a way that the individual conveyed goods carriers in the drum magazine are each aligned in a radial plane with respect to the axis of rotation of the drum magazine, so that each conveyed goods carrier located in the drum magazine is accessible for cleaning from above with its underside in one rotational position of the drum magazine and with its upper side in another rotational position of the drum magazine.

33. The planar-motor drive system according to claim 29, wherein
the magazine has an access opening for inserting a conveyed goods carrier to be cleaned into the magazine and for removing a cleaned conveyed goods carrier from the magazine,
the access opening has a locking mechanism which, only in an unlocked state, enables the removal of a conveyed goods carrier from the magazine or the insertion of a conveyed goods carrier into the magazine.

34. The planar-motor drive system according to claim 33, wherein
the locking mechanism of the access opening of the magazine is configured to unlock automatically when the cleaning device is coupled to the handling device of the planar-motor drive system, and
the locking mechanism of the access opening of the magazine is configured to lock automatically when the cleaning device is uncoupled from the handling device of the planar-motor drive system.

35. The planar-motor drive system according to claim 29, wherein the magazine for the conveyed goods carriers is arranged in a wire mesh cage, which is permeable to a cleaning fluid and makes it possible to clean the conveyed goods carriers located in the magazine from outside of the magazine by spraying the conveyed goods carriers with the cleaning fluid.
